(19) United States
(12) Patent Application Publication
(10) Pub. No.: US 2017/0131689 A1
(43) Pub. Date: May 11, 2017

(54) COMMUNICATION OF PHYSICAL SCENTS AND SCENT REPRESENTATIONS

(71) Applicant: International Business Machines Corporation, Armonk, NY (US)

(72) Inventors: Yuk L. Chan, Rochester, NY (US); Michael D. Essenmacher, Danbury, CT (US); David B. Lection, Raleigh, NC (US); Eric L. Masselle, Wake Forest, NC (US)

(21) Appl. No.: 14/934,211

(22) Filed: Nov. 6, 2015

(51) Int. Cl. G05B 15/02; H04W 4/00

(52) U.S. Cl. CPC G05B 15/02; H04W 4/008

(57) ABSTRACT

A computer system includes computer program instructions. The computer program instructions include instructions to receive one or more olfactory artefacts, and decode the one or more olfactory artefacts to yield a decoded scent. Responsive to the computer system being configured for olfactory generation, the computer program instructions further include instructions to generate an olfactory scent based on the decoded scent, and emit the olfactory scent. Responsive to the computer system not being configured for olfactory generation, the computer program instructions further include instructions to generate one or more scent representations from the decoded scent. Optionally, the computer program instructions include instructions to identify one or more olfactory artefacts, encode the olfactory artefact to yield an encoded scents, and export the encoded scent. Optionally, a computer program product includes instructions to identify an olfactory artefact, encode the olfactory artefact to yield an encoded scent, and export the encoded scent.

### BACKGROUND

The present invention relates generally to olfactory technology and in particular to interoperability of olfactory capable and non-olfactory capable devices.

The sense of smell is important to human perception of events, objects, and the surrounding environment. Moreover, common interactions involve scents from various sources. Thus, the ability to generate and detect odors has a wide range of applications. For example, scents may be employed in diverse industries such as foods and beverages (quality control, especially for wine and coffee), cosmetics (e.g., perfume), safety (e.g., detection of explosives and bacteria), medicine (e.g., detection of pneumonia, cancer, and other diseases), and automobiles (e.g., detection of pollutants in exhaust). Scents may also be employed as a means of social communication. Advancements in olfactory technology continue to present new possibilities and challenges.

### SUMMARY

A computer system includes one or more computer processors, one or more computer readable storage media, and computer program instructions. The computer program instructions are stored on the one or more computer readable storage media. The computer program instructions include instructions to receive one or more olfactory artefacts. The computer program instructions further include instructions to decode the one or more olfactory artefacts to yield a decoded scent. Responsive to the computer system being configured for olfactory generation, the computer program instructions further include instructions to generate an olfactory scent based on the decoded scent, and emit the olfactory scent. Responsive to the computer system not being configured for olfactory generation, the computer program instructions further include instructions to generate one or more scent representations from the decoded scent.

Optionally, a computer system includes one or more computer processors, one or more computer readable storage media, and computer program instructions. The computer program instructions are stored on the one or more computer readable storage media. The computer program instructions include instructions to identify one or more olfactory artefacts. The computer program instructions further include instructions to encode the one or more olfactory artefacts to yield an encoded scent. The computer program instructions further include instructions to export the encoded scent.

Optionally, a computer program product includes one or more computer readable storage media and program instructions stored on the one or more computer readable storage media. The program instructions include instructions to receive one or more olfactory artefacts. The program instructions further include instructions to decode the one or more olfactory artefacts to yield a decoded scent. Responsive to the computer program product being configured for olfactory generation, the program instructions further include instructions to generate an olfactory scent based on the decoded scent, and emit the olfactory scent. Responsive to the computer program product not being configured for olfactory generation, the program instructions further include instructions to generate one or more scent representations from the decoded scent.

Optionally, a computer program product includes one or more computer readable storage media and program instructions stored on the one or more computer readable storage media. The program instructions include instructions to identify one or more olfactory artefacts. The program instructions further include instructions to encode the one or more olfactory artefacts to yield an encoded scent. The program instructions further include instructions to export the encoded scent.

### BRIEF DESCRIPTION OF THE DRAWINGS

FIG. 1 is a block diagram of one embodiment of a computer system environment suitable for operation in accordance with at least one embodiment of the invention.

FIG. 2 is a block diagram of one embodiment of a computer system environment suitable for operation in accordance with at least one embodiment of the invention.

FIG. 3 is a network diagram of an operational environment for an olfactory communication program, in accordance with at least one embodiment of the invention.

FIG. 4 is a flow chart diagram depicting the olfactory communication program in accordance with at least one embodiment of the invention.

FIG. 5 is a flow chart diagram depicting the olfactory communication program in accordance with at least one embodiment of the invention.

FIG. 6 is a block diagram of a computing apparatus 600 suitable for executing the olfactory communication program in accordance with at least one embodiment of the invention.

### DETAILED DESCRIPTION

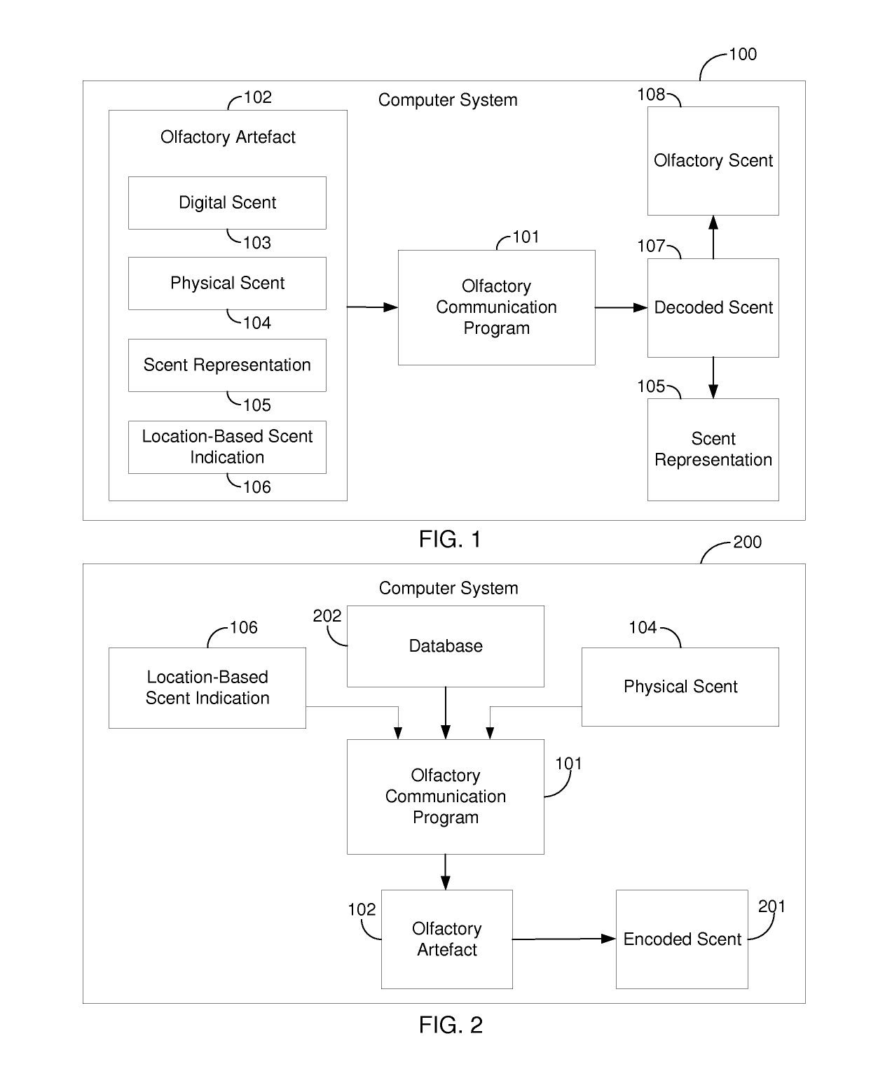

Referring now to various embodiments of the invention in more detail, FIG. 1 is a block diagram of one embodiment of a computer system environment suitable for operation in accordance with at least one embodiment of the invention. Within a computer system 100, an olfactory communication program 101 may receive one or more olfactory artefacts 102. The one or more olfactory artefacts 102 may include a digital scent 103, a physical scent 104, a scent representation 105, or a location-based scent indication 106. More specifically, a location-based scent indication 106 may include, but is not limited to, a wireless network signal, a radio frequency identification (“RFID”) signal, or a near field communication (“NFC”) signal. The olfactory communication program 101 may use any generally known RFID systems, such as a passive reader active tag (“PRAT”). With a PRAT, the RFID system includes a passive reader which only receives radio signals from active tags. The reception range of a PRAT system reader may be adjusted from 1-2,000 feet.

The olfactory communication program 101 may further decode the one or more olfactory artefacts 102 to yield a decoded scent 107.

Responsive to the computer system 100 being configured for olfactory generation, the olfactory communication program 101 may further generate an olfactory scent 108 based on the decoded scent 107. The olfactory communication program 101 may further emit the olfactory scent 108.

Responsive to the computer system 100 not being configured for olfactory generation, the olfactory communication program 101 may further generate one or more scent representations 105 from the decoded scent 107. A scent representation 105 may include, but is not limited to text, images, audio, and video that correlate to one or more physical scents 104. For example, the olfactory communication program 101 may generate a scent representation 105 in the form of an image of a skunk. In another example, the olfactory communication program 101 may generate a scent representation 105 in the form of sound recording data including the words “The scent of a skunk is in the area. Stay away.” In yet another example, the olfactory communication program 101 may generate a scent representation 105 in the form of textual data displaying the words “The scent of a skunk is in the area. Stay away.”

The computer system 100 may be configured to generate an olfactory scent 108 or a scent representation 105. More specifically, the computer system 100 may be configured to turn “ON” or turn “OFF” olfactory generation by the olfactory communication program 101. Here, the computer system 100 may be in a state where olfactory generation by the olfactory communication program 101 may be unwanted or impracticable. For example, olfactory generation may be turned OFF when generation of an olfactory scent 108 by the olfactory communication program 101 is unwanted (e.g., user device is in a hospital or school). In another example, generation of an olfactory scent 108 may be turned OFF when generation of an olfactory scent 108 by the olfactory communication program 101 is impracticable (e.g., user device is out of chemicals, there are too many competing smells, or the user has a poor sense of smell). Here, when the computer system 100 is not configured for generation of an olfactory scent 108, the olfactory communication program 101 may generate a scent representation 105.

FIG. 2 is a block diagram of one embodiment of a computer system environment suitable for operation in accordance with at least one embodiment of the invention. Within a computer system 200, the olfactory communication program 101 may identify one or more olfactory artefacts 102. In a computer system 200 that is configured for olfactory sensing, the olfactory communication program 101 may identify one or more olfactory artefacts 102 by sensing a physical scent 104. The olfactory communication program 101 may further generate one or more olfactory artefacts 102 based on the physical scent 104. The olfactory communication program 101 may further encode the one or more olfactory artefacts 102 to yield an encoded scent 201. The olfactory communication program 101 may further export the encoded scent 201.

In a computer system 200 that is not configured for olfactory sensing, the olfactory communication program 101 may identify one or more olfactory artefacts 102 by identifying a location-based scent indication 106 from at least one of the following: a wireless network signal, an RFID broadcast signal, or a NFC signal. The olfactory communication program 101 may further generate an olfactory artefact 102 based on the location-based scent indication 106. The olfactory communication program 101 may further encode the olfactory artefact 102 to yield an encoded scent 201. The olfactory communication program 101 may further export the encoded scent 201.

In both a computer system 200 that is configured for olfactory sensing and a computer system 200 that is not configured for olfactory sensing, exporting the encoded scent 201 may include, but is not limited to exporting the encoded scent to another device, exporting a radio frequency identification signal, exporting a scent representation, exporting the encoded scent to a social media application, displaying a scent representation, and emitting a physical scent.

In both a computer system 200 that is configured for olfactory sensing and a computer system 200 that is not configured for olfactory sensing, the olfactory communication program 101 may identify one or more olfactory artefacts 102 by receiving stored data from a database 202. The olfactory communication program 101 may further generate an olfactory artefact 102 based on the stored data from the database 202. The olfactory communication program 101 may further encode the olfactory artefact 102 to yield an encoded scent 201. The olfactory communication program 101 may further export the encoded scent 201.

The identification of a location-based scent indication 106 may be useful for an individual who has a health or dietary restriction. For example, an individual may have a medical condition that restricts the individual from consuming peanuts. In one scenario, the individual may be passing by a donut shop and the olfactory communication program 101, located on a user's 300 mobile device, may identify a “peanut” location-based scent indication 106 being broadcast by an RFID signal. The olfactory communication program 101 may further generate a “peanut” olfactory artefact 102 based on the RFID signal. The olfactory communication program 101 may further encode the “peanut” olfactory artefact 102 to yield a “peanut” encoded scent 201. The olfactory communication program 101 may further export the “peanut” encoded scent 201. Here, the olfactory communication program 101 may export the “peanut” encoded scent 201 by exporting a scent representation 105 on the user's 300 mobile device corresponding to the presence of peanuts.

For example, the olfactory communication program 101 may export a scent representation 105 by displaying an image of peanuts on the user's 300 mobile device. In another example, the olfactory communication program 101 may export a scent representation 105 by playing back sound recording data on the user's 300 mobile device including the words “The donut shop uses peanut products. Do not purchase any donuts from here.” In yet another example, the olfactory communication program 101 may export a scent representation 105 by displaying text (e.g., a push-up notification or SMS message) on the user's 300 mobile device including the words “The donut shop uses peanut products. Do not enter the donut shop.”

Similarly, the identification of a location-based scent indication 106 may be useful for an individual who may be deaf. For example, an individual may have a gas detection device in their home that broadcasts an alarm sound when the device has detected an unsafe concentration of gas. However, an individual who is deaf would not be able to hear the sound of the alarm. Thus, the sound of the alarm is worthless to an individual who is deaf.

Conversely, the gas detection device may broadcast a location-based scent indication 106 when the device has detected an unsafe concentration of gas. Here, the olfactory communication program 101, located on a user's 300 mobile device, may identify a “carbon monoxide gas” location-based scent indication 106 being broadcast from the gas detection device in the form of an RFID signal. The olfactory communication program 101 may further generate a “carbon monoxide gas” olfactory artefact 102. The olfactory communication program 101 may further encode the “carbon monoxide gas” olfactory artefact 102 to yield a “carbon monoxide gas” encoded scent 201. The olfactory communication program 101 may further export the “carbon monoxide gas” encoded scent 201. Here, the olfactory communication program 101 may export the “carbon monoxide gas” encoded scent 201 by exporting a scent representation 105 on the user's 300 mobile device corresponding to the presence of carbon monoxide gas.

For example, the olfactory communication program 101 may export a scent representation 105 by displaying an image of a carbon monoxide gas warning on the user's 300 mobile device. In another example, the olfactory communication program 101 may export a scent representation 105 by displaying text (e.g., a push-up notification or SMS message) on the user's 300 mobile device including the words “There is an unsafe concentration of carbon monoxide in the living room. Please exit the house immediately.”

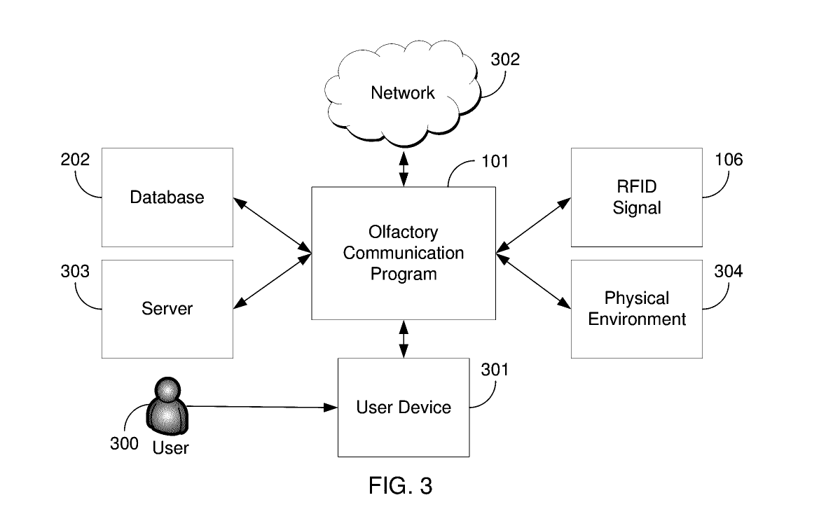

FIG. 3 is a network diagram of an operational environment for an olfactory communication program 101, in accordance with at least one embodiment of the invention. In FIG. 3, the olfactory communication program 101 may be in communication with a user 300 via a user device 301. More specifically, the olfactory communication program 101 may receive an olfactory artefact 102 from the user device 301. The one or more olfactory artefacts 102 may be accessible by a user 300 via a number of environments, including a network 302, such as the Internet, locally stored data on a user device 301, such as a desktop computer or mobile device, from a database 201, or from a remote location, such as a server 303. Additionally, the olfactory communication program 101 may be in communication with a location-based scent indication 106 via a wireless network, RFID, or NFC, or a physical scent 104 via the physical environment 304.

In general, embodiments of the invention may export the encoded scent 201 to a number of environments, including a user device 301, such as a desktop computer or mobile device, a database 201, or a remote location, such as a server 303. More specifically, the olfactory communication program 101 may export the encoded scent 201 to a remote location, such as a server 303 that can execute one or more services in connection with displaying the encoded scent 201. For example, the server 303 may execute a social networking service (“SNS”), an email delivery service, or a website production service.

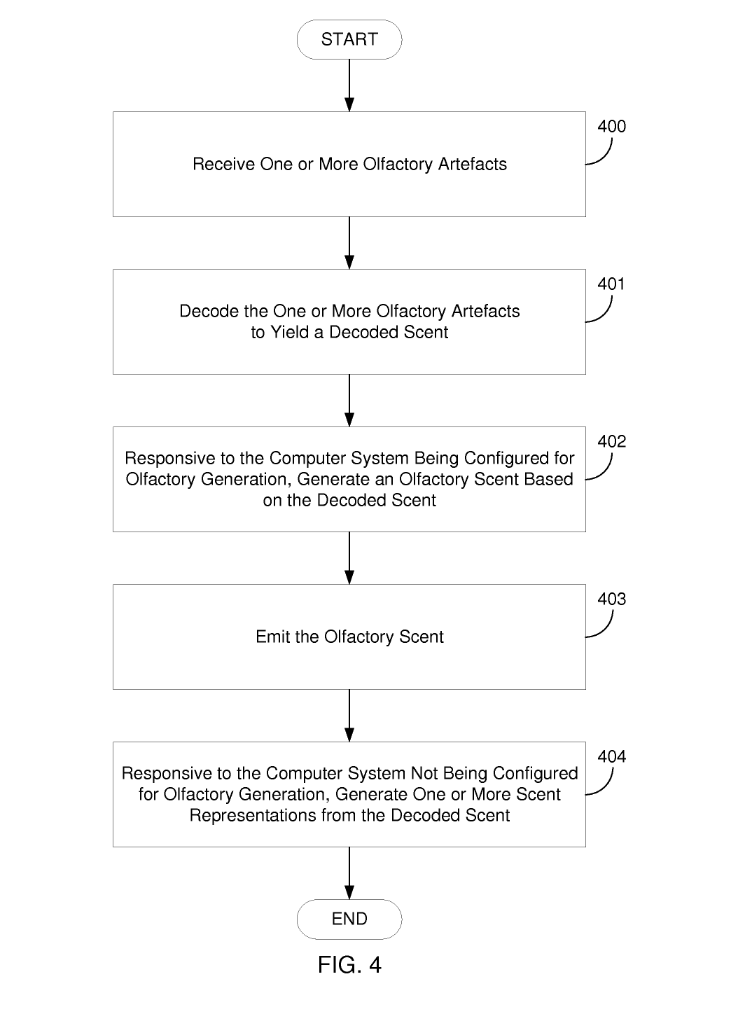

FIG. 4 is a flow chart diagram depicting the olfactory communication program in accordance with at least one embodiment of the invention. According to the depicted embodiment, at step 400, the olfactory communication program 101 may receive one or more olfactory artefacts 102. The one or more olfactory artefacts 102 may include a digital scent 103, physical scent 104, scent representation 105, or location-based scent indication 106. The location-based scent indication 106 may include, but is not limited to: a wireless network signal, a RFID signal, or a NFC signal.

More specifically, a scent representation 105 may include any means of representing a scent on an electronic device. A scent representation 105 may include, but is not limited to text, images, audio, and video that correlate to one or more physical scents 104. For example, the olfactory communication program 101 may receive a scent representation 105 in the form of an image of a rose. In another example, the olfactory communication program 101 may receive a scent representation 105 in the form of sound recording data on a user's 300 mobile device including the words “The scent of roses is in the air.” In yet another example, the olfactory communication program 101 may receive a scent representation 105 in the form of textual data displaying the words “The scent of roses is in the air.”

At step 401, the olfactory communication program 101 may decode the one or more olfactory artefacts 102 to yield a decoded scent 107. The olfactory communication program 101 may decode the one or more olfactory artefacts 102 by any generally known decoding methods.

At step 402, responsive to the computer system being configured for olfactory generation, the olfactory communication program 101 may generate an olfactory scent 108 based on the decoded scent 107. The olfactory scent 108 may be generated based on any generally known scent generation methods. For example, the olfactory communication program 101 may generate an olfactory scent 108 through the use of one or more scent cartridges. The scent cartridges, like cartridges in an inkjet printer, may include chemical reagents. The chemical reagents may be in the form of a solid, liquid or gas.

At step 403, the olfactory communication program 101 may emit the olfactory scent 108. The olfactory scent 108 may be emitted based on any generally known scent emission methods. For example, in the case of scent cartridges including chemical reagents in a solid form, the chemical reagents may be temperature activated. Here, the scent reagents in a solid form, when heated, will become vaporized. In another example, in the case of scent cartridges including chemical reagents in a liquid form, the liquid reagents may be heated, causing a portion of the liquid to become vaporized. The chemical reagents in both the solid form and liquid form, after being transformed into a vapor, may then be emitted by a stream of moving air, which flows out of the device to the user 300. In yet another example, in the case of scent cartridges including chemical reagents in a gas form, the use of regulators may be controlled to emit appropriate volumes of gas.

At step 404, responsive to the computer system not being configured for olfactory generation, the olfactory communication program 101 may generate one or more scent representations 105 from the decoded scent 107.

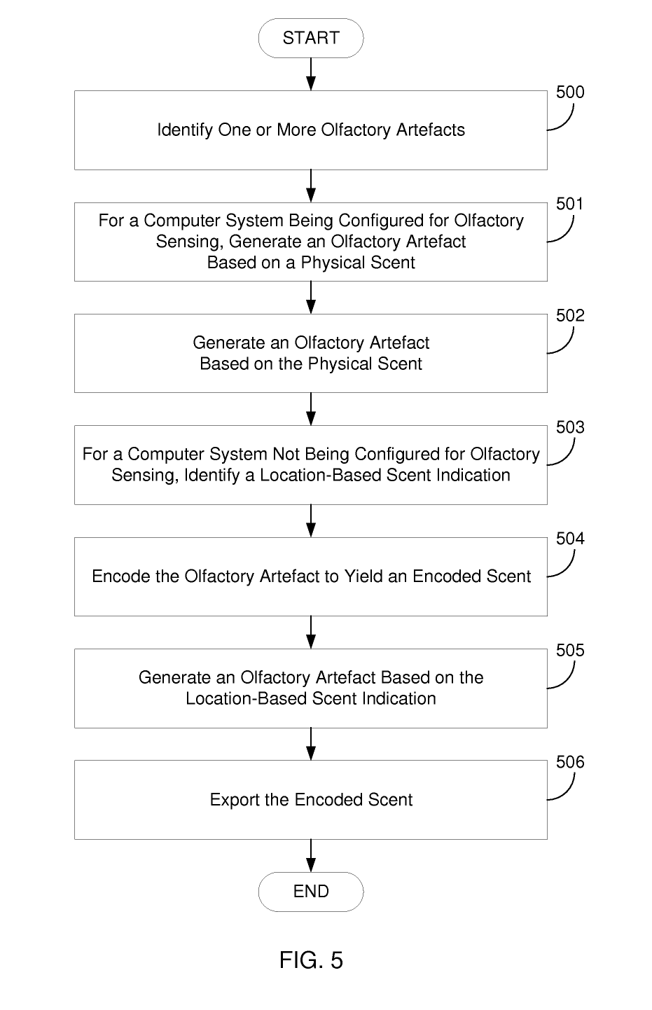

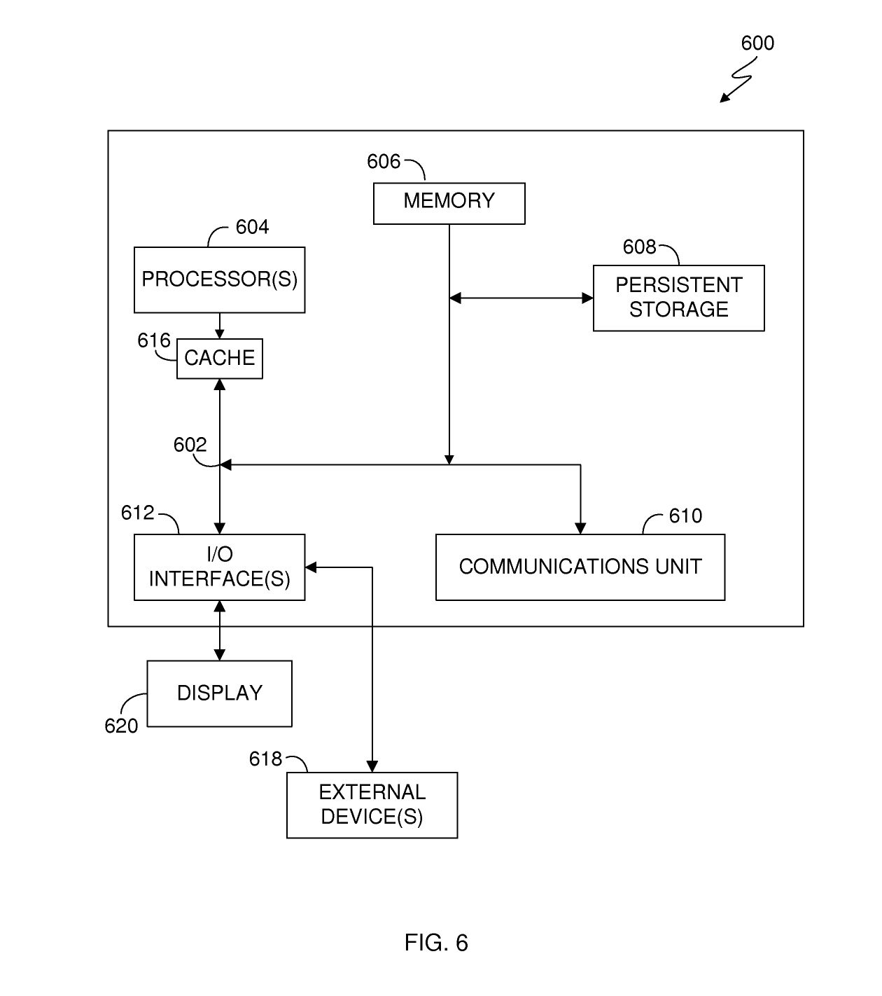

FIG. 5 is a flow chart diagram depicting the olfactory communication program in accordance with at least one embodiment of the invention. According to the depicted embodiment, at step 500, the olfactory communication program 101 may identify one or more olfactory artefacts 102. At step 501, in the case of the computer system 200 being configured for olfactory sensing, identifying one or more olfactory artefacts 102 may further include sensing a physical scent 104. A physical scent 104 may be sensed by any generally known olfactory sensing methods using an “artificial nose.”

For example, an artificial nose may include one or more conducting polymer sensors. Each sensor may consist of three components: a substrate, a pair of gold-plated electrodes, and a conducting organic polymer layer. Instead of an organic polymer layer, each sensor may be replaced with SnO₂ or platinum pellistor-type elements. Similarly, an array of chemiresistors, formed of a mixture of a conducting element, (e.g., carbon or polypyrrole), with a non-conducting polymer, may be used. When the sensor is exposed to an analyte, the conducting organic polymer firm swells, which causes an increase in resistance because the conductive pathways through the materials are disrupted. The pattern of the resistance change over the one or more sensors provides the evidence for qualitative classification of different smell patterns.

Additionally, to achieve amplification of odorant molecules, the increase in sensors may provide an increase in the detection area. Furthermore, aerogel technology may be used to achieve a hundred-fold to possibly even a million-fold increase in surface area by expanding the sensor surface into the third dimension. Other surface increasing materials may also be used.

In another example, an artificial nose may include a surface acoustic wave (“SAW”) sensor. Here, the artificial nose may allow volatile compounds to be absorbed. The absorbed compounds are then vaporized by heating the compounds. The vaporized compounds may then be separated based on their different solubility (similar to gas chromatography).

In yet another example, an artificial nose may be in the form of a quartz-crystal microbalance (“QCM”) apparatus that detects crystal frequency shift. Here, the frequency shift of a piezoelectric crystal attached to the polymer-coated aerogel is measured. In addition to the above mentioned sensing methods, resonant micro-mechanical structures based on integrated circuit micro-fabrication may be implemented in more compact and low-power devices.

At step 502, the olfactory communication program 101 may generate an olfactory artefact 102 based on the physical scent 104.

At step 503, in the case of the computer system 200 not being configured for olfactory sensing, identifying one or more olfactory artefacts 102 may include identifying a location-based scent indication 106. The location-based scent indication 106 may be in the form of a wireless network signal, an RFID signal, or a NFC signal. In addition to identifying an olfactory artefact 102 by identifying a location-based scent indication 106, the olfactory communication program 101 may identify an olfactory artefact 102 by receiving stored data from a database 202. The database 202 may be accessible by a user 300 via a number of environments, including locally stored data on a user device 301, such as a desktop computer or mobile device, network 302, such as the Internet, or from a remote location, such as a server 303. At step 504, the olfactory communication program 101 may generate an olfactory artefact 102 based on the location-based scent indication 106.

At step 505, the olfactory communication program 101 may encode the olfactory artefact 102 to yield an encoded scent 201. At step 506, the olfactory communication program 101 may export the encoded scent 201. The encoded scent 201 may be exported by any generally known export methods. For example, the encoded scent 201 may be exported to a social network application. Here, the encoded scent 201 may be displayed on a social media application, such as Facebook, Twitter, or Instagram. In another example, the encoded scent 201 may be exported over a network 302, such as the Internet or to a remote location, such as a server 303. In a further example, the encoded scent may be exported to a user device 301, such as a desktop computer or mobile device. In yet a further example, the olfactory communication program 101 may export the encoded scent 201 by emitting a physical scent 104 into the physical environment 304. In yet another example, the olfactory communication program 101 may export the encoded scent 201 by broadcasting an RFID signal.

FIG. 6 is a block diagram depicting components of a computer 600 suitable for executing the olfactory communication program 101. FIG. 6 displays the computer 600, the one or more processor(s) 604 (including one or more computer processors), the communications fabric 602, the memory 606, the RAM 616, the cache 618, the persistent storage 608, the communications unit 612, the I/O interfaces 614, the display 622, and the external devices 620. It should be appreciated that FIG. 6 provides only an illustration of one embodiment and does not imply any limitations with regard to the environments in which different embodiments may be implemented. Many modifications to the depicted environment may be made.

As depicted, the computer 600 operates over a communications fabric 602, which provides communications between the computer processor(s) 604, memory 606, persistent storage 608, communications unit 612, and input/output (I/O) interface(s) 614. The communications fabric 602 may be implemented with any architecture suitable for passing data or control information between the processors 604 (e.g., microprocessors, communications processors, and network processors), the memory 606, the external devices 620, and any other hardware components within a system. For example, the communications fabric 602 may be implemented with one or more buses.

The memory 606 and persistent storage 608 are computer readable storage media. In the depicted embodiment, the memory 606 comprises a random access memory (RAM) 616 and a cache 618. In general, the memory 606 may comprise any suitable volatile or non-volatile one or more computer readable storage media.

Program instructions for the olfactory communication program 101 may be stored in the persistent storage 608, or more generally, any computer readable storage media, for execution by one or more of the respective computer processors 604 via one or more memories of the memory 606. The persistent storage 608 may be a magnetic hard disk drive, a solid state disk drive, a semiconductor storage device, read-only memory (ROM), electronically erasable programmable read-only memory (EEPROM), flash memory, or any other computer readable storage media that is capable of storing program instructions or digital information.

The media used by the persistent storage 608 may also be removable. For example, a removable hard drive may be used for persistent storage 608. Other examples include optical and magnetic disks, thumb drives, and smart cards that are inserted into a drive for transfer onto another computer readable storage medium that is also part of the persistent storage 608.

The communications unit 612, in these examples, provides for communications with other data processing systems or devices. In these examples, the communications unit 612 may comprise one or more network interface cards. The communications unit 612 may provide communications through the use of either or both physical and wireless communications links. In the context of some embodiments of the present invention, the source of the source of the various input data may be physically remote to the computer 600 such that the input data may be received and the output similarly transmitted via the communications unit 612.

The I/O interface(s) 614 allow for input and output of data with other devices that may operate in conjunction with the computer 600. For example, the I/O interface 614 may provide a connection to the external devices 620, which may be as a keyboard, keypad, a touch screen, or other suitable input devices. External devices 620 may also include portable computer readable storage media, for example thumb drives, portable optical or magnetic disks, and memory cards. Software and data used to practice embodiments of the present invention may be stored on such portable computer readable storage media and may be loaded onto the persistent storage 608 via the I/O interface(s) 614. The I/O interface(s) 614 may similarly connect to a display 622. The display 622 provides a mechanism to display data to a user and may be, for example, a computer monitor.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of computer program instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer system comprising:
one or more computer processors;
one or more computer readable storage media; and
computer program instructions;
said computer program instructions being stored on said one or more computer readable storage media; and
said computer program instructions comprising instructions to:
receive one or more olfactory artefacts;
decode said one or more olfactory artefacts to yield a decoded scent;
responsive to said computer system being configured for olfactory generation:
generate an olfactory scent based on said decoded scent; and
emit said olfactory scent; and
responsive to said computer system not being configured for olfactory generation, generate one or more scent representations from said decoded scent.

2. The computer system of claim 1, wherein:
said computer system is configured for olfactory sensing; and
said computer program instructions to receive one or more olfactory artefacts comprise instructions to receive a digital scent.

3. The computer system of claim 1, wherein said computer program instructions to receive one or more olfactory artefacts comprise instructions to receive a physical scent.

4. The computer system of claim 1, wherein said program instructions to receive one or more olfactory artefacts comprise instructions to receive a scent representation.

5. The computer system of claim 1, wherein:
said computer system is configured for olfactory sensing; and
said computer program instructions to receive one or more olfactory artefacts comprise instructions to receive a location-based scent indication.

6. The computer system of claim 5, wherein said location-based scent indication includes at least one of the following: a wireless network signal, a radio frequency identification signal, and a near field communication signal.

7. A computer system comprising:
one or more computer processors;
one or more computer readable storage media; and
computer program instructions;
said computer program instructions being stored on said one or more computer readable storage media; and
said computer program instructions comprising instructions to:
identify one or more olfactory artefacts;
encode said one or more olfactory artefacts to yield an encoded scent; and
export said encoded scent.

8. The computer system of claim 7, wherein:
said computer system is configured for olfactory sensing; and
said computer program instructions to identify one or more olfactory artefacts further comprise instructions to:
sense a physical scent; and
generate an olfactory artefact based on said physical scent.

9. The computer system of claim 7, wherein said computer program instructions to identify one or more olfactory artefacts further comprise instructions to:
identify a location-based scent indication; and
generate an olfactory artefact based on said location-based scent indication.

10. The computer system of claim 7, wherein said computer program instructions to export said encoded scent comprise instructions to perform at least one step selected from the group consisting of:
(a) export said encoded scent to another device;
(b) export a radio frequency identification broadcast;
(c) export a scent representation;
(d) export said encoded scent to a social media application;
(e) display a scent representation; and
(f) emit a physical scent.

11. The computer system of claim 7, wherein said computer program instructions to identify an olfactory artefact comprise instructions to:
receive stored data from a database; and
generate an olfactory artefact based on said stored data.

12. The computer system of claim 7, wherein said computer program instructions to identify an olfactory artefact comprise instructions to:
receive a location-based scent indication; and
generate an olfactory artefact based on said location-based scent indication.

13. The computer system of claim 12, wherein said location-based scent indication includes at least one of the following: a wireless network signal, a radio frequency identification signal, and a near field communication signal.

14. A computer program product, the computer program product comprising one or more computer readable storage media and program instructions stored on said one or more computer readable storage media, said program instructions comprising instructions to perform at least one of:
(1) receive one or more olfactory artefacts;
decode said one or more olfactory artefacts to yield a decoded scent;
responsive to said computer program product being configured for olfactory generation:
generate an olfactory scent based on said decoded scent; and
emit said olfactory scent; and
responsive to said computer program product not being configured for olfactory generation, generate one or more scent representations from said decoded scent; and
(2) identify one or more olfactory artefacts;
encode said one or more olfactory artefacts to yield an encoded scent; and
export said encoded scent.

15. The computer program product of claim 14, wherein:
said computer program product is configured for olfactory sensing; and
said instructions to receive one or more olfactory artefacts comprise instructions to receive a physical scent.

16. The computer program product of claim 14, wherein said instructions to receive one or more olfactory artefacts comprise instructions to perform at least one step selected from the group consisting of:
(a) receive a digital scent;
(b) receive a scent representation;
(c) receive a location-based scent indication; and
(d) receive a physical scent.

17. The computer program product of claim 16, wherein said location-based scent indication includes at least one of the following: a wireless network signal, a radio frequency identification signal, and a near field communication signal.

18. The computer program product of claim 14, wherein said instructions to export said encoded scent comprise instructions to perform at least one step selected from the group consisting of:
(a) export said encoded scent to another device;
(b) export said encoded to a social media application;
(c) export a physical scent into the environment;
(d) export a radio frequency identification signal;
(e) export a near field communication signal;
(f) export a wireless network communication signal;
(g) export a scent representation;
(h) export a digital scent; and
(i) display a scent representation.

19. The computer program product of claim 14, wherein said instructions to identify an olfactory artefact comprise instructions to:
receive a location-based scent indication; and
generate an olfactory artefact based on said location-based scent indication.

20. The computer program product of claim 19, wherein said location-based scent indication includes at least one of the following: a wireless network signal, a radio frequency identification signal, and a near field communication signal.
